(19) United States
(12) Patent Application Publication
(10) Pub. No.: US 2026/0029868 A1
(43) Pub. Date: Jan. 29, 2026

(54) TOUCH PANEL HAVING TOUCH ELECTRODE AND SENSOR SIGNAL LINE WITH IMPROVED VISIBILITY

(71) Applicant: G2touch Co., Ltd., Seongnam-si (KR)

(72) Inventors: Hwa-Joo NOH, Seongnam-si (KR); Seung-Seob CHOI, Seongnam-si (KR)

(21) Appl. No.: 19/206,099

(22) Filed: May 13, 2025

(30) Foreign Application Priority Data
Jul. 26, 2024 (KR) 10-2024-0099051

(51) Int. Cl. G06F 3/041; G06F 3/044

(52) U.S. Cl. CPC G06F 3/04164; G06F 3/044; G06F 2203/04112

(57) ABSTRACT

Disclosed is a touch panel having a touch electrode and a sensor signal line with improved visibility, and more particularly a touch panel having a touch electrode and a sensor signal line with improved visibility, the touch panel including a touch electrode configured to generate a touch signal by approach or touch of a touch means, a sensor signal line configured to transmit the touch signal generated by the touch electrode to a touch IC, and a mesh pattern formed on an inner surface of each of the touch electrode and the sensor signal line, wherein each of the mesh pattern of the touch electrode and the mesh pattern of the sensor signal line is formed by repeatedly patterning a hexagonal shape.

### BACKGROUND OF THE INVENTION

### Field of the Invention

The present invention relates to a touch panel capable of detecting capacitive touch input from a human finger or a touch tool having conductive properties similar thereto, and more particularly to a touch panel having a touch electrode and a sensor signal line with improved visibility.

### Description of the Related Art

In general, a touch panel is attached to a display device such as a liquid crystal display (LCD), a plasma display panel (PDP), an organic light emitting diode (OLED), or an active matrix organic light emitting diode (AMOLED), and is a type of input device that generates a signal corresponding to the position touched by an object such as a finger or a pen.

In recent years, touch panels have been used in a wide range of fields, including small mobile devices, industrial terminals, and digital information devices (DIDs), and the use thereof is expanding.

FIGS. 1A, 1B and 1c are views showing examples of a touch electrode of a conventional capacitive touch panel. A capacitive touch panel is a device that generates a predetermined capacitance between a human finger or a touch input tool with similar conductive properties thereto and a touch electrode (conductive material) of the touch panel and determines whether touch occurs based on the change in voltage across the generated capacitance.

Recently, as the resolution of touch panels required by smartphones and the like has increased, a touch electrode constituting the touch panel has become more sophisticated and diversified in order to accurately and quickly determine the touch position.

FIGS. 1A, 1B and 1C show examples of a conventional capacitive touch electrode, wherein two pieces 110a and 110b are disposed face to face to form a unit pattern 100 (FIG. 1A), and the entirety of a shape 120 or 140 forms a unit pattern (FIG. 1B and FIG. 1C).

In the conventional touch panel illustrated in FIGS. 1A, 1B and 1C, the size of each of the unit patterns 100, 120, and 140 is reduced when the touch panel is manufactured, whereby resolution is increased. However, as the size of the unit pattern decreases, the number of touch signal lines connected to the unit pattern increases exponentially. As the number of touch signal lines increases, the area occupied by the touch signal lines on the touch panel increases, which is undesirable for the overall performance of the touch panel.

In addition, the mesh pattern forming the sensor signal line of the conventional capacitive touch panel is usually formed in a quadrangular shape or a rhombus shape, and the sensor signal line must be separated so as to match the row of each touch electrode. However, a method of separating different sensor signal lines from the conventional rhombus-shaped mesh pattern increases the proportion of the wiring area, which causes a decrease in touch performance.

If a wiring structure having a shape different from the rhombus shape is applied in order to reduce the proportion of the wiring area of the sensor signal lines caused by the conventional rhombus-shaped mesh pattern, a problem of visibility arises due to the concentration of the mesh pattern in the area where the wires are separated.

The above information disclosed in this Related Art section is only for enhancement of understanding of the background of the present invention and thus does not form the prior art known to those skilled in the art.

### SUMMARY OF THE INVENTION

It is an object of the present invention to provide a touch panel in which a hexagonal mesh pattern is formed on each of a touch electrode and a sensor signal line such that the area where the touch electrode is disposed and the area of the sensor signal line are not displayed in a separated state, whereby visibility of the touch panel is improved.

Objects of the present invention are not limited to the above object, and other unmentioned objects will be clearly understood by those skilled in the art based on the following description.

In order to accomplish the above object, the present invention provides a touch panel having a touch electrode and a sensor signal line with improved visibility, the touch panel including a touch electrode configured to generate a touch signal by approach or touch of a touch means, a sensor signal line configured to transmit the touch signal generated by the touch electrode to a touch IC, and a mesh pattern formed on an inner surface of each of the touch electrode and the sensor signal line, wherein each of the mesh pattern of the touch electrode and the mesh pattern of the sensor signal line is formed by repeatedly patterning a hexagonal shape.

In the present invention, the mesh pattern of the sensor signal line may have separation lines of the sensor signal line formed by separating a part of the hexagonal shape.

In the present invention, the mesh pattern of the sensor signal line may have separation lines of the sensor signal line formed by separating an upper area and a lower area of the hexagonal shape from each other.

In the present invention, each of the separation lines of the sensor signal line may be formed in a straight line shape.

In the present invention, each of the separation lines of the sensor signal line may be formed in a zigzag shape.

In the present invention, the mesh pattern may be formed as a metal pattern, and the metal pattern may be made of a conductive paste including at least one selected from the group consisting of silver (Ag), palladium (Pd), niobium (Nb), tantalum (Ta), vanadium (V), indium (In), gallium (Ga), cadmium (Cd), zinc (Zn), tin (Sn), and an alloy thereof.

### BRIEF DESCRIPTION OF THE DRAWINGS

FIGS. 1A, 1B and 1C are views showing examples of a touch electrode of a conventional capacitive touch panel;

FIG. 2A is a plan view showing the structure of a first pattern (basic unit pattern) of a touch electrode according to an embodiment of the present invention;

FIG. 2B is a plan view showing a second pattern constituting the first pattern of FIG. 2A:

FIG. 3 is a view schematically showing the structure of an M×N matrix touch panel according to an embodiment of the present invention;

FIG. 4 is an enlarged view of the touch electrode according to the present invention, wherein part A′ of FIG. 2A is enlarged;

FIG. 5 is a view showing an embodiment of the structure of a touch panel according to the present invention;

FIG. 6 is an enlarged view of part B′ of FIG. 4, showing the structure of a mesh pattern of a conventional touch electrode;

FIG. 7 is an enlarged view of part B′ of FIG. 4, showing the structure of a mesh pattern of the touch electrode according to the present invention;

FIG. 8 is a view showing the structure of the mesh pattern of the touch electrode according to the present invention;

FIGS. 9A and 9B are enlarged views of part C′ of FIG. 4, showing the structure of a mesh pattern of a sensor signal line according to the present invention;

FIG. 10 is a view showing that a sensor signal line is constituted by separating the structure of a mesh pattern of a conventional sensor signal line; and

FIGS. 11A and 11B are views showing that a sensor signal line is constituted by separating the structure of a mesh pattern of the sensor signal line according to the present invention.

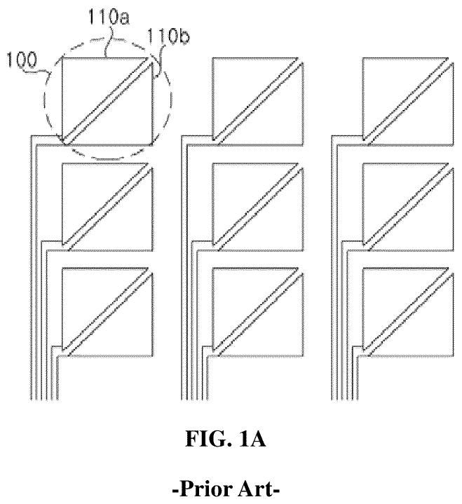

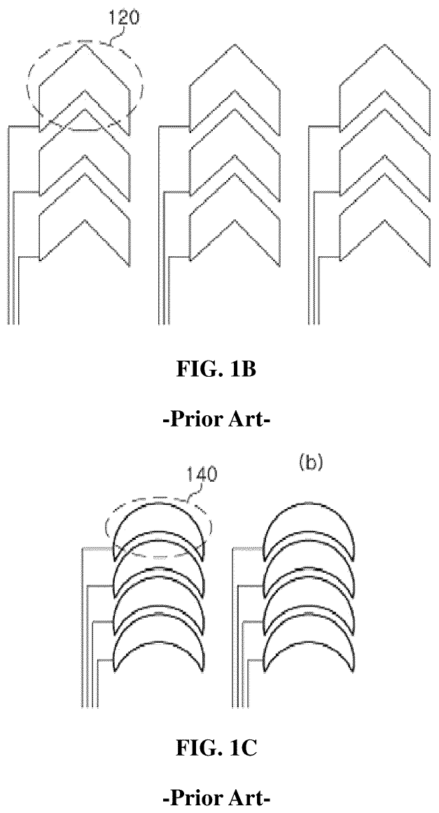

### DETAILED DESCRIPTION OF THE INVENTION

Hereinafter, preferred embodiments of the present invention will be described in detail with reference to the accompanying drawings. It should be understood that the terms or words used in the specification and appended claims should not be construed as being limited to general and dictionary meanings, but should be construed based on meanings and concepts according to the technical idea of the present invention on the basis of the principle that the inventor is permitted to define appropriate terms for the best explanation. Accordingly, embodiments described in this specification and constructions shown in the drawings are merely the most preferred embodiment of the present invention and do not represent the entirety of the technical idea of the present invention, and therefore it should be understood that various replaceable equivalents and modifications may be possible at the time of filing the present application.

In general, in a touch electrode of a touch panel, a metal mesh pattern of the touch electrode is located at an upper end of a display, light transmittance thereof is low due to the characteristics of the material, and a wide spacing of the metal mesh is required in order to increase the transmittance of the display. However, even though the spacing of the metal mesh of the touch electrode is wide, complexity in wiring of a sensor signal line causes a wiring area of the sensor signal line to occupy a certain amount of space in the touch panel.

For example, a self-dot touch panel requires wiring of sensor signal lines equal in number to the rows (e.g., 25 lines for 15.6″), and a wiring area of more than 40% of the X-size of a sensor cell is necessary to satisfy the minimum spacing of the mesh pattern required to increase light transmittance. However, if the wiring area occupies more than 40% of the X-size of the sensor cell, a dead zone is formed, which causes deterioration in touch performance.

Conventionally, therefore, various wiring structures have been proposed in order to reduce the proportion of the wiring area of the sensor signal line, but the concentration of the mesh pattern in the area where the wires of the sensor signal line are separated from each other causes visibility problems.

For example, in a conventional rhombus-shaped mesh pattern, a mesh structure of an active area is the same, but a mesh structure of a wiring area of a sensor signal line is different from the rhombus shape, causing visibility problems.

That is, a method of separating sensor signal lines of different shapes with the conventional rhombus-shaped mesh pattern increases the proportion of the wiring area, which causes a decrease in touch performance. The present invention proposes a mesh pattern in which the touch electrode and the sensor signal line are formed in the form of a hexagon (honeycomb) in order to dramatically improve this, and such a hexagon-shaped mesh pattern significantly reduces the visible wiring area compared to a method of forming a conventional mesh pattern including a touch electrode and sensor signal lines of different shapes.

Meanwhile, in the present invention, the term “touch panel” refers to a capacitive touch panel, which is a device capable of generating a predetermined capacitance between a human finger or a touch input tool having similar conductive characteristics thereto and the touch electrode of the touch panel and determining whether touch occurs based on a change of voltage in the generated capacitance.

The touch electrode in the present invention is made of a conductive material and may also be referred to as a touch pattern or a sensing electrode. The “improving the visibility of the touch panel” in the present invention should be interpreted broadly to include remedying the non-visibility of the touch electrode and the moiré phenomenon. That is, improving the visibility of the touch panel is intended to ensure that a screen is not blurred or the touch electrode is not recognized when a user operates a device.

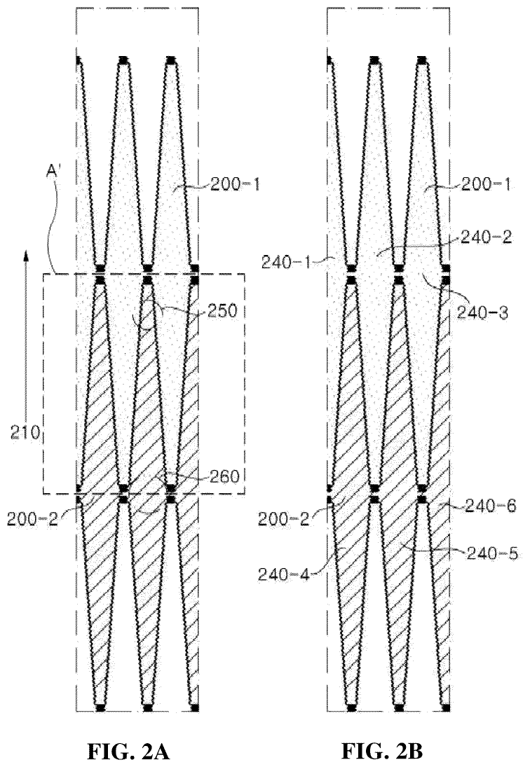

FIG. 2A is a plan view showing the structure of a first pattern (basic unit pattern) 200-1 or 200-2 of a touch panel according to an embodiment of the present invention.

In the present invention, each column of the touch panel is formed by repeatedly disposing a shape in which the first pattern 200-1 of the touch electrode and the second pattern 200-2 of the touch electrode are interlocked with each other from top to bottom with their phases reversed by 180 degrees from left to right, and the whole is formed such that a rhombus shape is repeatedly disposed.

As shown in FIGS. 2A and 2B, a column is formed by repeatedly disposing a shape in which the first pattern and the second pattern of the touch electrode of a similar shape are interlocked with each other with the left and right sides reversed in a direction indicated by the arrow 210, i.e., in a longitudinal direction. A plurality of columns formed in the same manner is repeatedly disposed to form the touch electrode of the touch panel.

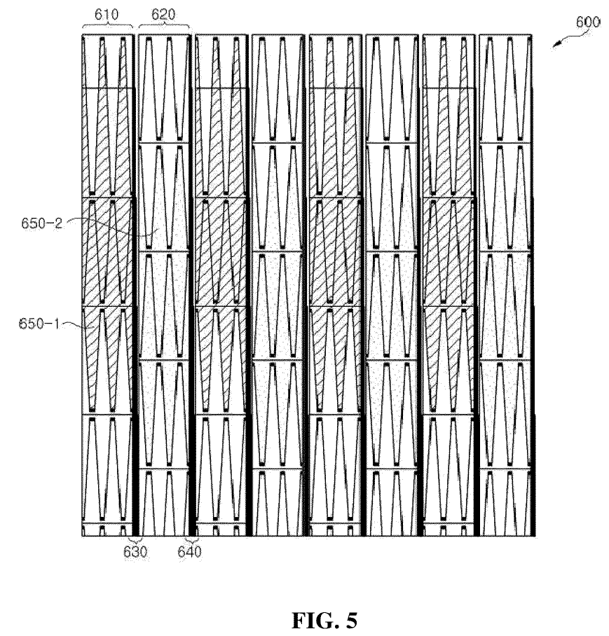

The overall shape of the touch panel will be described in more detail with reference to FIG. 5, but the unit pattern is the first pattern 200-1 or 200-2 shown in FIG. 2A. In the present invention, the unit pattern refers to a touch electrode connected to one sensor signal line.

As described above, a column is formed by repeatedly disposing a shape in which two first patterns are interlocked with each other with the left and right sides reversed in the direction indicated by the arrow 210, i.e., in the longitudinal direction. A touch panel according to an embodiment of the present invention is formed by repeatedly disposing a plurality of columns formed in the same manner.

Specifically, pairs of basic unit patterns (first patterns 200-1 and 200-2) are repeatedly disposed such that the vertices thereof are interlocked with each other to form a single column. Each of the first patterns is made of a conductive material and may generate a touch capacitance Ct by approach or touch of a touch means.

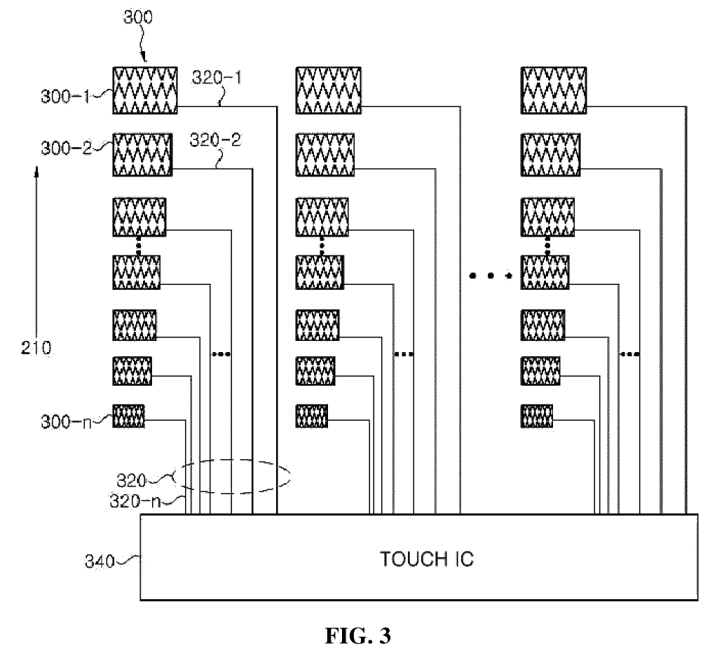

The touch capacitance generated by approach or touch of the touch means is within the range of a few fF (femto farads) to tens of uF (microfarads). In the present invention, not only the first pattern 200-1 or 200-2 but also the sensor signal line 320 (FIG. 3) may be made of a conductive material. Since the first pattern 200-1 and the first pattern 200-2 are different unit patterns, the first patterns are connected to different sensor signal lines to transmit received touch signals to a touch IC 340.

The touch IC 340 of the present invention refers to a device that detects whether touch occurs and a touch point based on a touch signal received via the sensor signal line 320. The touch IC 340 is typically disposed in an outer edge area of the touch panel, and the specific position thereof may vary depending on the use or size of the touch panel.

FIG. 2B is a plan view of a second pattern constituting the first pattern of FIG. 2A.

As shown in FIG. 2B, the first pattern 200-1 or 200-2 of each touch electrode is formed by connecting at least one second pattern to each other. Specifically, the first pattern 200-1 is formed by connecting second patterns 240-1, 240-2, and 240-3 to each other, and the first pattern 200-2 is formed by connecting second patterns 240-4, 240-5, and 240-6 to each other.

The example of forming the unit pattern shown in FIG. 2B is only an example, and the number of second patterns forming the first pattern may vary depending on the use or size of the touch panel. In addition, although each first pattern is shown as being formed by connecting 2.5 second patterns to each other in FIG. 2B, the number of second patterns constituting the first pattern is variable depending on the resolution, such as 3, 3.5, 4, or 4.5.

In the 2.5, 3.5, or 4.5 second patterns, the 0.5 second pattern represents half of the pattern 240-2, such as the pattern 240-1 and the pattern 240-6. That is, the shape of the second pattern constituting the first pattern is divided by ½ in the direction indicated by the arrow 210 to refer to the half area thereof.

In this way, one or more second patterns are connected to each other to form a first pattern, which is a unit pattern, and one column of the touch panel is formed by repeatedly disposing a shape in which a pair of first patterns is interlocked with each other from top to bottom with their phases reversed by 180 degrees.

The detection of a touch point in the touch panel according to the present invention is specifically performed by using the difference in voltage received at the touch point 250 or 260 upon the occurrence of a touch at that point between the time when the touch occurred and the time when no touch occurred.

FIG. 3 is a view schematically showing the structure of an M×N matrix touch panel according to an embodiment of the present invention.

As shown in FIG. 3, a touch IC 340 configured to determine whether touch occurs is disposed on the downstream side opposite the direction indicated by the arrow 210.

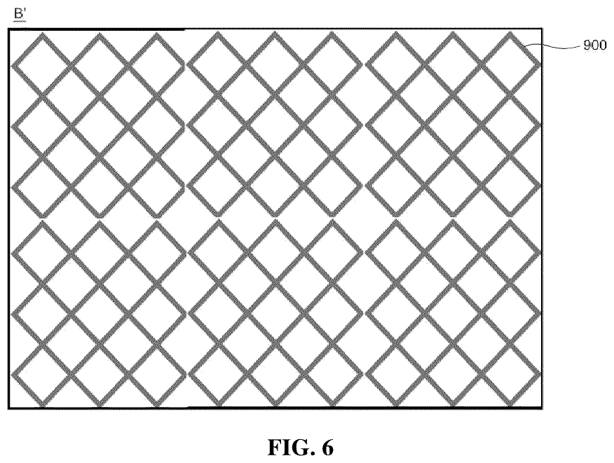

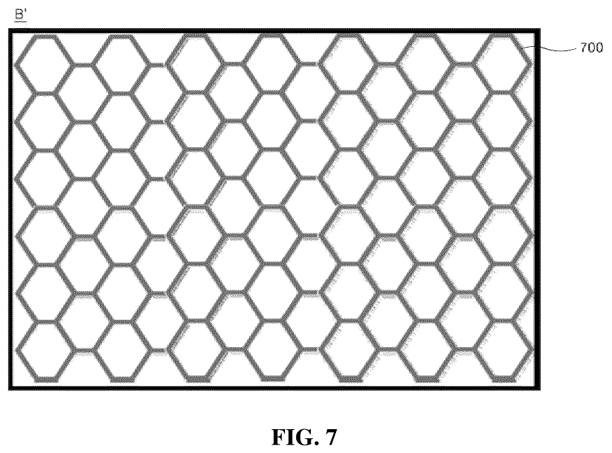

In FIG. 3, the first pattern, which is a unit pattern of the touch electrode, has the same structure as the first pattern 200-1 or 200-2 in FIG. 2. Although neighboring patterns 300-1 and 300-2 of the touch electrode are shown as being disposed with a predetermined spacing therebetween in FIG. 3, they are shown to facilitate understanding of the overall change in the size of the touch electrode and the change in the sensor signal line in the entire touch panel, and strictly speaking, the spacing between neighboring patterns forming a single column is not required (see FIG. 6, etc.).

As shown in FIG. 3, the size of the first pattern 300-1 disposed farthest away from the touch IC 340 is greater than the size of the first pattern 300-n disposed nearest to the touch IC 340.

In the embodiment of the present invention, the overall size of the first pattern 300-1 increases in the direction indicated by the arrow 210. That is, specifically, the size of the touch electrode 300-n closest to the touch IC 340 is less than the size of the touch electrode 300-1. Strictly speaking, an increase in the overall size of the first pattern may mean an increase in the width of the second pattern constituting the first pattern, and may also mean an increase in the number of second patterns constituting the first pattern.

The increase in the number of second patterns may be used to reduce the size of a unit pi (e.g., 1 mm) for high resolution, but the width of the second pattern may be varied in the case of a change in the size of the first pattern with distance from the touch IC 340. In general, as the size of the first pattern increases in the direction indicated by the arrow 210 or with distance from the touch IC 340, the width of the signal line 320 also increases.

The change in size of the touch electrode and the change in width of the sensor signal line disclosed in relation to FIG. 3 are intended to compensate for resistance loss caused as the touch signal is transmitted along the sensor signal line.

For example, assuming that the voltage change generated in the first pattern 300-n is a touch threshold voltage that can be recognized as a touch, if the same touch threshold voltage is generated in the first pattern 300-1, the voltage generated in the first pattern 300-1 is transmitted along the sensor signal line 320-1, the signal amplitude is reduced according to the resistance of the sensor signal line, and eventually the touch IC does not recognize the touch in the first pattern 300-1.

As a result, an error may occur in which the touch IC detects that a touch has occurred in the first pattern 300-n, but not in the first pattern 300-1, even though a touch of the same size has occurred.

Therefore, in order to solve the problem of recognizing a touch occurrence at one touch electrode and no touch occurrence at the other touch electrode for the same touch, the present invention not only changes the size of the unit pattern (increasing the width of the second pattern) by considering the distance from the touch IC, but also changes the width of the sensor signal line connected to the pattern (increasing the width) at the same time.

As mentioned above, the width of the sensor signal line and the size of the first pattern are set to ensure that the resistance values of the sensor signal lines are the same. At the same time, the spacing between the sensor signal lines in the present invention also increases as the width of the sensor signal line increases.

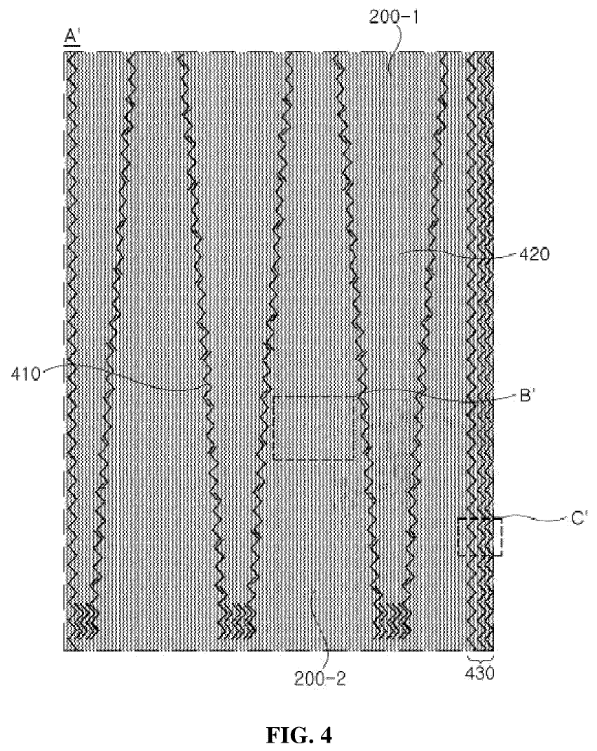

The sensor signal line 320 of the present invention is formed by patterning a plurality of mesh patterns 440-1 to 440-4, in the same manner as the touch electrode. However, in order to distinguish neighboring sensor signal lines from each other, a hexagonal mesh pattern with a conductive material removed is continuously connected along separation lines 880 and 890. The separation lines for distinguishing the sensor signal lines are shown in an area 430 of FIG. 4.

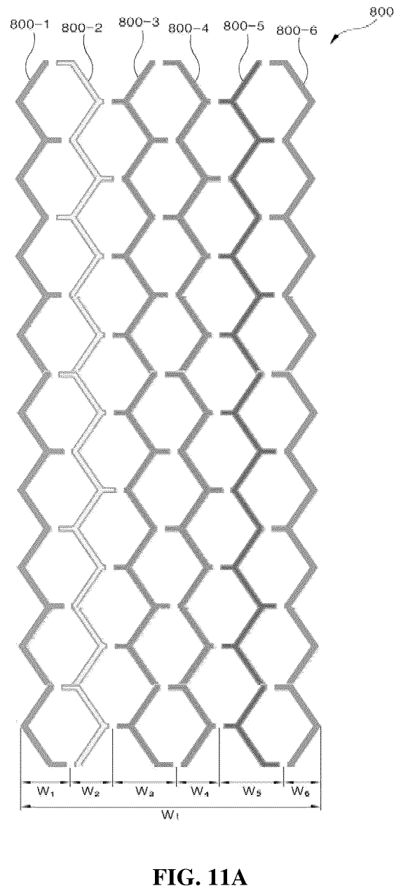

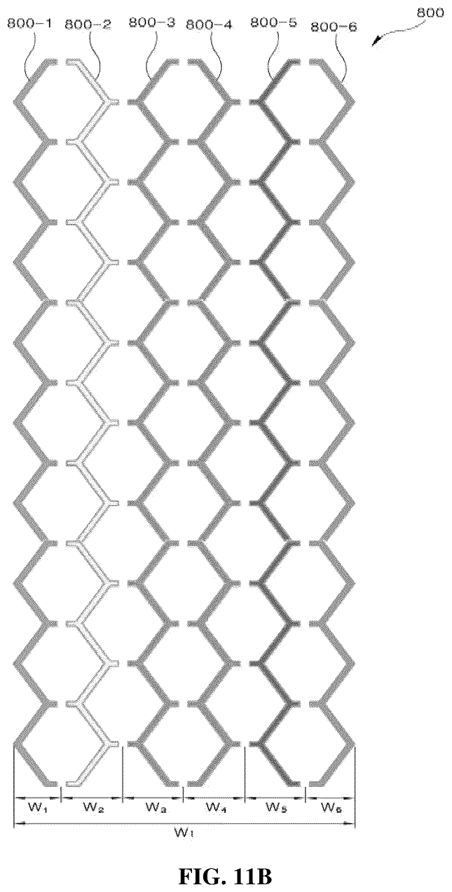

In the embodiment of the present invention, the spacing between the separation lines shown in the area 430 of FIG. 4 increases with distance from the touch IC. When the area 430 of FIG. 4 is enlarged, a sensor signal line configuration shown in FIGS. 11A and 11B, which will be described in detail later, is formed.

FIG. 4 is an enlarged view of the touch electrode according to the present invention, wherein part A′ of FIG. 2A is enlarged. That is, FIG. 4 is an enlarged view showing the boundaries of the patterns disposed adjacent to each other of the first pattern 200-1 and the first pattern 200-2 in FIGS. 2A-2B.

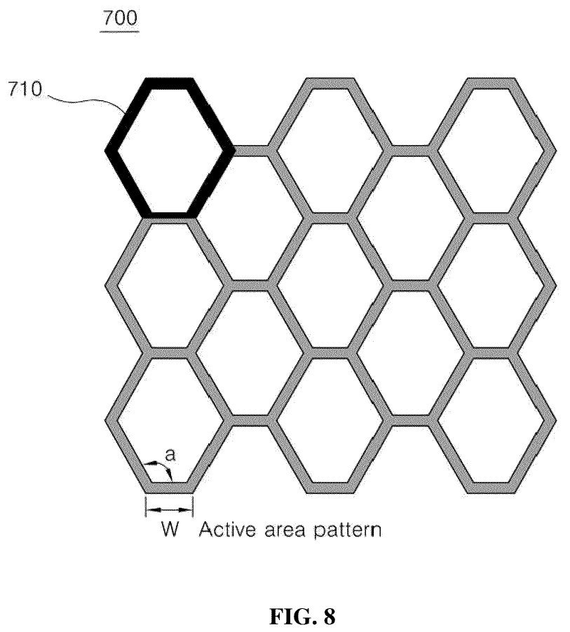

The touch electrode and sensor signal line of the present invention are formed by repeated patterning of a plurality of hexagonal mesh patterns in order to improve visibility. That is, the touch electrode of the present invention is patterned with a hexagonal mesh pattern 700 using a metal conductive material in the inner area of one or 0.5 rhombuses of the second pattern (see FIG. 7).

In the present invention, visibility refers to the ability to prevent a user from recognizing that the touch electrode are formed on the touch panel, such as in the first pattern 200-1 or 200-2 of the touch electrode.

Referring to FIG. 4, each side of the rhombus of the first pattern of the touch electrode may be formed in a zigzag shape 410 by repeated patterning of a hexagonal mesh pattern. Each side of the rhombus of the first pattern of the touch electrode may form a closed-loop area by connecting one or more repeatedly patterned mesh patterns to each other.

FIG. 5 is a view showing an embodiment of the structure of the touch panel according to the present invention.

FIG. 5 is a view schematically showing two columns of a matrix form including a plurality of columns M and a plurality of rows N. A pair of first patterns shown in the first column 610 is shown as patterns 650-1, and a pair of first patterns shown in the second column 620 is shown as patterns of 650-2.

The patterns 650-1 and the patterns 650-2 shown in FIG. 5 are identical to the patterns shown in FIG. 2A. That is, a pair of first patterns of the same shape is interlocked with each other from top to bottom with their phases reversed by 180 degrees.

An area 630 where sensor signal lines connected to the patterns of the first column are disposed and an area 640 where sensor signal lines connected to the patterns of the second column are disposed are shown. The touch electrode according to the embodiment shown in FIG. 6 is configured such that the patterns 610 of the first column and the patterns 620 of the second column are disposed staggered from each other so as to have a predetermined offset.

The structure in which the first column 610 and the second column 620 shown in FIG. 5 are disposed so as to have a predetermined offset will be described in detail in comparison to the touch electrode of FIG. 3. The pattern 300-1, 300-2, or 300-n in FIG. 3 corresponds to the pattern 650-1 or 650-2 in FIG. 6.

As already discussed above, no gap is required between the patterns in FIG. 3, and the patterns may be disposed so as to be continuously connected to each other, as shown in FIG. 5.

In FIG. 3, the touch electrodes are disposed in a matrix form, and the touch electrodes in the first column and the remaining columns are all disposed side by side. That is, the patterns in the first column, the second column, or the remaining columns are disposed in line on one row (hereinafter referred to as a “stripe structure”).

In contrast, in the touch electrodes shown in FIG. 5, the touch electrode 650-1 of the first column and the touch electrode 650-2 of the second column are staggered while having a predetermined offset rather than forming one row side by side.

Specifically, the pattern 650-2 in the second column is disposed farther downward toward the touch IC than the pattern 650-1 in the first column.

The touch panel according to the embodiment shown in FIG. 5 can more easily detect multiple touches than a touch panel having a striped structure. In the embodiment of FIG. 5, the pattern is illustrated as having an offset along the column, but it is possible for the pattern to have an offset along the row depending on the type of disposition with the touch IC.

FIG. 6 is an enlarged view of part B′ of FIG. 4, showing the structure of a mesh pattern of a conventional touch electrode.

The metal mesh pattern of the conventional touch electrode is formed in a rhombus or diamond shape because the material has low light transmittance and the metal mesh must be widely spaced to increase the transmittance of the display.

As described above, the self-dot touch panel requires wiring of sensor signal lines equal in number to the rows, and when a rhombic mesh pattern 900 is adopted, a wiring area of more than 40% of the X-size of the sensor cell is necessary to satisfy the minimum spacing of the mesh pattern required to increase light transmittance. However, if the wiring area occupies more than 40% of the X-size of the sensor cell, the wiring acts as a dead zone, which causes deterioration in touch performance.

Therefore, the present invention adopts a hexagonal touch electrode mesh pattern that does not require a wiring area of more than 40% of the X-size, and also adopts a matching hexagonal mesh pattern of the sensor signal line.

FIG. 7 is an enlarged view of part B′ of FIG. 4, showing the structure of a mesh pattern of the touch electrode according to the present invention.

The present invention includes a touch electrode configured to generate a touch signal by approach or touch of a touch means, a sensor signal line configured to transmit the touch signal generated by the touch electrode to a touch IC, and a mesh pattern formed on an inner surface of each of the touch electrode and the sensor signal line.

In the present invention, the mesh pattern 700 of the touch electrode is formed in the form of a honeycomb with a hexagonal shape repeatedly patterned. Similarly, the mesh pattern 800 of the sensor signal line of the present invention is formed in the form of a honeycomb with a hexagonal shape repeatedly patterned to improve visibility.

Each of the mesh pattern 700 of the touch electrode and the mesh pattern 800 of the sensor signal line is formed as a metal pattern made of a conductive paste including a metal or a metal alloy in a powder form.

Each of the mesh pattern 700 of the touch electrode and the mesh pattern 800 of the sensor signal line may be patterned using a conductive paste including at least one selected from the group consisting of silver (Ag), palladium (Pd), niobium (Nb), tantalum (Ta), vanadium (V), indium (In), gallium (Ga), cadmium (Cd), zinc (Zn), tin (Sn), and an alloy thereof.

Here, the conductive paste may further include at least one of a solvent, a polymer binder, a dispersant, a curing agent, and an antifoaming agent, in addition to a metal such as silver (Ag), zinc (Zn), or tin (Sn). The metal or the metal alloy included in the conductive paste may include more than 20 parts by weight to 35 parts by weight based on 100 parts by weight of the conductive paste.

Each of the mesh pattern 700 of the touch electrode and the mesh pattern 800 of the sensor signal line may be formed by forming a mesh pattern on a substrate using the conductive paste including the metal or the metal alloy, heat-treating the mesh pattern formed on the substrate, and pressing the heat-treated mesh pattern.

In the present invention, gravure offset, reverse offset, screen printing, or gravure printing may be used as a method of forming the mesh pattern on the substrate using the conductive paste.

It is preferable for the mesh pattern formed on the substrate to be heat-treated at a heat treatment temperature of 80° C. to 270° C. In addition, the heat-treated mesh pattern may be pressed at a pressure of 3 MPa to 24 MPa for 2 to 12 seconds.

For reference, in forming the mesh pattern, substances such as the solvent, the binder, and the dispersant contained in the conductive paste may be volatilized, whereby pores may be formed, during a heat treatment process, and the heat-treated mesh pattern may be pressed to remove the pores formed during the heat treatment process, thereby reducing the surface roughness of an upper part of the mesh pattern, increasing packing density between particles, and improving the electrical properties.

FIG. 8 is a view showing the structure of the mesh pattern of the touch electrode according to the present invention.

In the structure of the mesh pattern of the touch electrode according to the present invention, a unit pattern 710 of the mesh pattern of the touch electrode is hexagonal, and the hexagonal unit pattern is repeatedly patterned along the columns and rows to form a honeycomb shape.

Furthermore, as mentioned above, in the touch panel according to the present invention, the visibility of the touch electrode is maximally improved by repeatedly patterning not only the mesh pattern 700 forming the touch electrode but also the sensor signal line with the same shape of the mesh pattern.

Meanwhile, the variable elements of the mesh patterns for determining the length, width, etc. of each of the unit pattern 710 of the mesh pattern of the touch electrode and the unit pattern 810 of the mesh pattern of the sensor signal line may include an interior angle A formed by two line segments of a hexagon and a width W corresponding to the length of the line segment of the hexagon, for example, as shown in FIG. 8.

That is, in a subsequent design or manufacturing process for forming the mesh pattern, the area of the mesh patterns that overlap the pixel units of the same color of the display may be determined by adjusting one or more of the variable elements.

Meanwhile, when the shape and arrangement of the mesh pattern are determined, a shape (e.g., a zigzag shape) in which some patterns of a hexagonal shape are connected in a longitudinal direction may be derived from the outside of the sensor signal line on which the mesh pattern is formed.

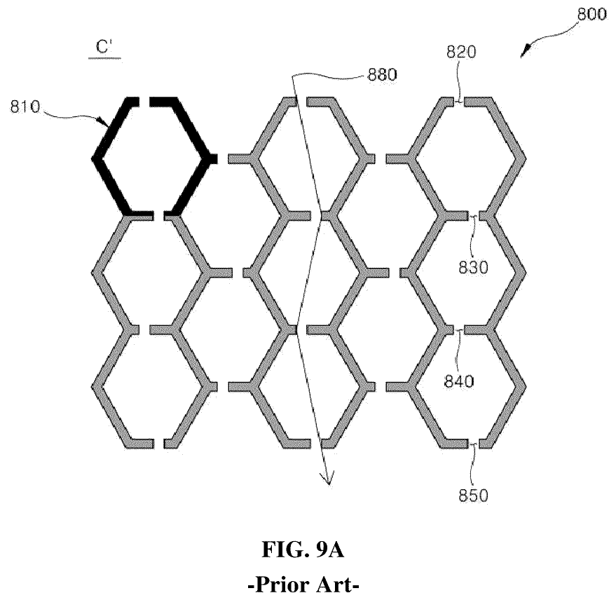

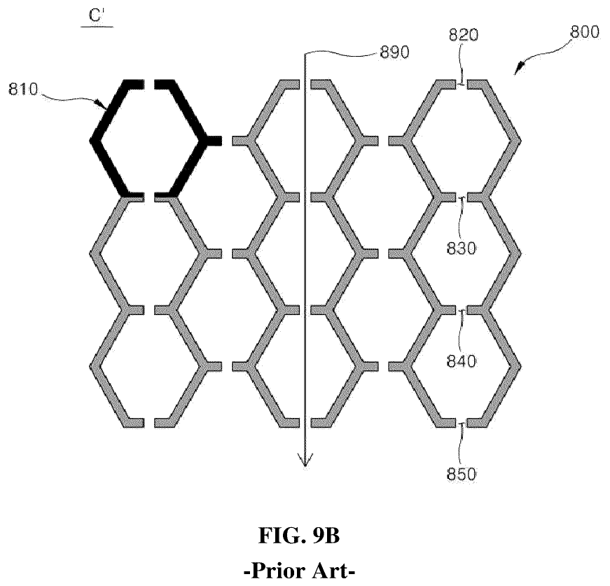

FIGS. 9A and 9B are enlarged views of part C′ of FIG. 4, showing the structure of the mesh pattern of the sensor signal line according to the present invention.

In the present invention, the mesh pattern 800 of the sensor signal line may have separation lines 880 and 890 of the sensor signal line formed by separating a part of a hexagonal shape. The separation lines may include a straight separation line 890 and a zigzag separation line 880.

The mesh pattern 800 of the sensor signal line may have separation lines 880 and 890 of the sensor signal line formed by separating an upper area and a lower area of each hexagonal shape from each other.

More strictly speaking, for each unit pattern 810 of the mesh pattern of the sensor signal line, the upper and lower areas may be separated to form the separation lines 880 and 890 of the sensor signal line. In this way, the separation areas 820 and 830 may be formed by separating a part of the upper area of the unit pattern 810 of the mesh pattern of the sensor signal line and separating a part of the lower area thereof, whereby signal lines of the mesh pattern of the sensor signal line 800 may be separated from each other, and spaced apart from each other, and withdrawn.

In FIGS. 9A and 9B, the separation areas of the mesh pattern of the sensor signal line are denoted by reference numerals 820, 830, 840, and 850. For example, reference numeral 830 may function as a lower separation area for the unit pattern of the mesh pattern of the sensor signal line located above or as an upper separation area for the unit pattern of the mesh pattern of the sensor signal line located below.

The separation lines 880 and 890 of the sensor signal line perform a function of connecting sub-patterns formed by separating a part of a hexagonal shape without a gap in the longitudinal direction, thereby isolating neighboring sensor signal lines from each other.

Meanwhile, the separation line of the sensor signal line may be formed in a straight line shape by forming separation areas on a vertical line, as shown in FIG. 9B.

However, the present invention is not limited thereto, and the separation line of the sensor signal line may also be formed in a zigzag shape by forming the upper separation area and the lower separation area so as to be divergent from each other with respect to a vertical line, as shown in FIG. 9A, as needed.

In this way, the present invention has the advantage that two signal lines can be withdrawn per column of the unit pattern 810 of the mesh pattern of the sensor signal line, thereby reducing the width of the area occupied by the sensor signal line.

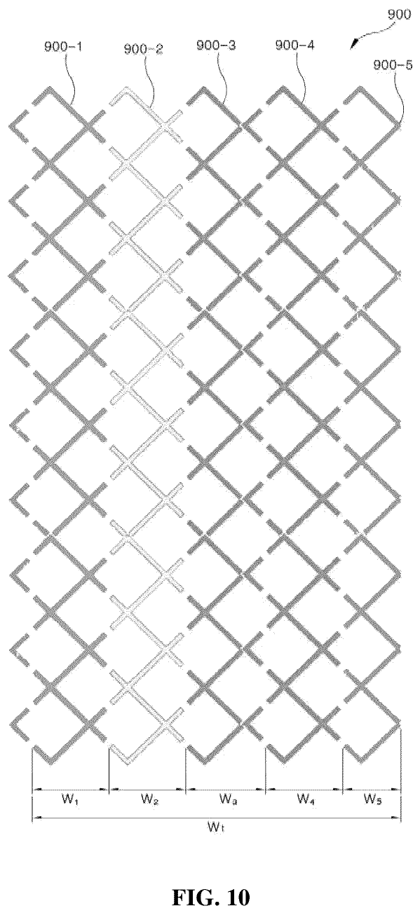

FIG. 10 is a view showing that a sensor signal line is constituted by separating the structure of a mesh pattern of a conventional sensor signal line.

Referring to FIG. 10, the mesh pattern 900 of the conventional sensor signal line is formed by repeatedly patterning a rhombus shape in columns or rows.

For the mesh pattern 900 of the conventional sensor signal line, sensor signal lines 900-1, 900-2, 900-3, 900-4, and 900-5 are isolated by separating a part of the rhombus shape, but it is conventionally possible to constitute a separation line as shown in FIG. 10 due to the structure of the rhombus shape.

That is, if the vertex part of the rhombus shape is cut off, there is a structural problem that the mesh patterns of the separated sensor signal lines may not be connected to each other in the longitudinal direction, whereby the separation lines are constituted by removing the area that is not the vertex part of the rhombus shape.

However, if the mesh pattern of the sensor signal line is separated, as shown in FIG. 10, the width of the area occupied by the sensor signal line increases, and the total width Wt of the sensor signal lines also increases, which increases the risk of forming a dead zone.

That is, according to the conventional rhombus-shaped mesh pattern, the wiring area of more than 40% of the X-size of the sensor cell is occupied, and the wiring of each signal line acts as a dead zone, causing deterioration in touch detection performance.

FIGS. 11A and 11B are views showing that the sensor signal line is constituted by separating the structure of the mesh pattern of the sensor signal line according to the present invention.

Referring to FIGS. 11A and 11B, the mesh pattern 800 of the sensor signal line according to the present invention is formed in the shape of a hexagonal honeycomb, and thus has a structural feature in which sensor signal lines can be connected in the longitudinal direction and withdrawn even if a part of each of the upper and lower areas of the hexagonal unit pattern is separated.

In FIGS. 11A and 11B, sensor signal lines 800-1, 800-2, 800-3, 800-4, 800-5, and 800-6 can be colored in red, yellow, green, blue, purple, and gray, respectively, and when the separation line is configured as a vertical line or a zigzag shape by removing a part of each of the upper and lower sides of the hexagonal unit patterns, some patterns with a left part or a right part of the hexagon removed constitute each sensor signal line in the longitudinal direction.

For each of the sensor signal lines 800-1, 800-2, 800-3, 800-4, 800-5, and 800-6 according to the present invention, therefore, any one of a [symbol] -shaped sub-pattern, a [symbol] -shaped sub-pattern, of a [symbol] -shaped sub-pattern, and a [symbol] -shaped sub-pattern is provided in plural so as to be connected to each other in the longitudinal direction, whereby a single sensor signal line is withdrawn and extends to the touch IC.

For reference, the sub-pattern of each sensor signal line has a shape in which the end of the inequality sign shape is bent and extended horizontally or a combination of a shape in which the end of the inequality sign shape is bent and extended horizontally and a shape in which the vertex of the inequality sign shape is extended horizontally, and these sub-patterns are connected to each other in the longitudinal direction to form each sensor signal line in a zigzag shape.

In the present invention, as described above, the sensor signal line is formed in a hexagonal mesh pattern, whereby the width of the area occupied by each sensor signal line or the total width Wt of the sensor signal lines is significantly decreased compared to a conventional rhombus-shaped mesh pattern.

Furthermore, according to the present invention, the wiring area of the X-size of the sensor cell is reduced compared to a conventional one, and therefore the wiring of each sensor signal line does not act as a dead zone, resulting in better touch detection performance.

As such, the present invention has the advantage that not only the mesh pattern forming the touch electrode but also the sensor signal line is repeatedly patterned so as to have the same hexagonal honeycomb mesh pattern, whereby the visibility of the touch panel is improved, and the width of the area occupied by the sensor signal line is greatly reduced compared to the conventional rhombic pattern, whereby the effect of noise is significantly reduced, resulting in improved touch performance.

Meanwhile, the present invention may be applied to a display device including the touch panel as needed. For example, the touch panel according to the present invention may be applied to a display device such as a liquid crystal display (LCD), a plasma display panel (PDP), an organic light emitting diode (OLED), or an active matrix organic light emitting diode (AMOLED).

As is apparent from the above description, embodiments of the present invention have the effect that a plurality of hexagonal mesh patterns is formed on a touch electrode and a sensor signal line such that the area where the touch electrode is disposed and the area of the sensor signal line are not displayed in a separated state, whereby visibility of a touch panel is greatly improved.

Effects of the present invention are not limited to the above effect, and other unmentioned effects will be clearly understood by those skilled in the art based on the above description.

The present invention has been described above with reference to the specific embodiments of the present invention, but this is by way of example only and the present invention is not limited thereto. Those skilled in the art to which the present invention pertains may make changes or modifications in the described embodiments without departing from the scope of the present invention, and various modifications and modifications may be made within the technical idea of the present invention and the equivalent scope of the claims set forth below.

1. A touch panel having a touch electrode and a sensor signal line with improved visibility, the touch panel comprising:
a touch electrode configured to generate a touch signal by approach or touch of a touch means;
a sensor signal line configured to transmit the touch signal generated by the touch electrode to a touch IC; and
a mesh pattern formed on an inner surface of each of the touch electrode and the sensor signal line,
wherein each of the mesh pattern of the touch electrode and the mesh pattern of the sensor signal line is formed by repeatedly patterning a hexagonal shape.

2. The touch panel according to claim 1, wherein the mesh pattern of the sensor signal line has separation lines of the sensor signal line formed by separating a part of the hexagonal shape.

3. The touch panel according to claim 1, wherein the mesh pattern of the sensor signal line has separation lines of the sensor signal line formed by separating an upper area and a lower area of the hexagonal shape from each other.

4. The touch panel according to claim 3, wherein each of the separation lines of the sensor signal line is formed in a straight line shape.

5. The touch panel according to claim 3, wherein each of the separation lines of the sensor signal line is formed in a zigzag shape.

6. The touch panel according to claim 1, wherein
the mesh pattern is formed as a metal pattern, and
the metal pattern is made of a conductive paste comprising at least one selected from a group consisting of silver (Ag), palladium (Pd), niobium (Nb), tantalum (Ta), vanadium (V), indium (In), gallium (Ga), cadmium (Cd), zinc (Zn), tin (Sn), and an alloy thereof.
